(19) United States
(12) Patent Application Publication
(10) Pub. No.: US 2009/0021949 A1
(43) Pub. Date: Jan. 22, 2009

(54) Lighting System Having a Flat Lamp, and a Frame with a Section which can be Folded

(75) Inventors: Jurgen Beck, Heuchlingen (DE); Bert Schlenga, Giengen (DE)

Correspondence Address: OSRAM SYLVANIA INC, 100 ENDICOTT STREET, DANVERS, MA, 01923, US

(73) Assignee: OSRAM GESELLSCHAFT MIT BESCHRANKTER HAFTUNG, MUNCHEN (DE)

(21) Appl. No.: 12/224,838

(22) PCT Filed: Mar. 2, 2007
(86) PCT No.: PCT/EP2007/052028

§ 371 Date: Oct. 6, 2008

(30) Foreign Application Priority Data
Mar. 8, 2006 (DE) 10 2006 010 791.8

(51) Int. Cl. F21V 15/00

(52) U.S. Cl. 362/362

(57) ABSTRACT

The invention is based on an illuminating system with a frame (2) and a flat lamp (5) arranged therein. The frame (2) is configured as a hinged frame with a hinge-mounted portion (7). This allows the flat lamp (5) to be easily fitted and removed.

### TECHNICAL FIELD

The invention is based on a lighting system having a frame, and having a flat lamp arranged therein.

Lighting systems such as these are used for many lighting purposes, in particular also for lights for general illumination, as well as for background lighting of liquid crystal displays (LCD)—where they are also referred to as backlight units (BLU). In particular, large-format LCD televisions may be mentioned for background lighting tasks, which have become increasingly important recently.

The expression “flat lamp” in this case means lamps, in particular fluorescent lamps, with a flat geometry, which emit white or colored light, as well as UV light as well, for special applications.

In addition to conventional flat lamps with a mercury and/or noble gas filling, one particular aim of the invention is flat lamps of the dielectric barrier discharge lamp type. In this lamp type, either the electrodes of one polarity or else all the electrodes, that is to say the electrodes of both polarities, are separated from the discharge by means of a dielectric layer (discharge with a dielectric barrier on one side or two sides). Electrodes such as these are also referred to for short in the following text as “dielectric electrodes”. Furthermore, it should also be explained that the dielectric layer need not be a layer applied to an electrode specifically for this purpose but, for example, may also be formed by a discharge vessel wall, specifically when the electrodes, which are typically in the form of strips or lines, are arranged on the outside of a discharge vessel wall or within the wall.

Flat lamps of the dielectric barrier discharge lamp type have been found to be particularly efficient flat light sources when they are operated using the pulsed operating method, as described in U.S. Pat. No. 5,604,410, and are therefore particularly highly suitable for use in a light or a backlight unit.

### PRIOR ART

The document EP 1 600 808 A1 discloses a lighting system having a flat lamp. There, the flat lamp is inserted into a housing with a rear wall and a circumferential side wall. A frame which is plugged onto the side wall and is likewise circumferential fixes the flat lamp within the housing, protecting it against breakage.

### DESCRIPTION OF THE INVENTION

The object of the present invention is to provide a further lighting system having a flat lamp, in which the flat lamp can be replaced easily and is nevertheless reliably mechanically protected.

This object is achieved by a lighting system having a flat lamp which has a front face, which is intended for light emission, and a rear face opposite the front face, a frame which surrounds the edge of the flat lamp, characterized in that the frame has a section which can be folded and, when in the unfolded state, is suitable to allow the insertion of the flat lamp and, in the folded-up state, fixes the frame around the flat lamp.

Particularly advantageous refinements can be found in the dependent claims.

The frame according to the invention therefore has a section which can be folded and which preferably frames the front face of the flat lamp, when in the folded-up state. The section of the frame which can be folded is preferably subdivided into segments which can be folded independently, for example four, with each segment in each case being associated with one edge of the flat lamp. Once all the segments have been folded up, the flat lamp can be installed or removed without any problems. A latching-in means is preferably provided, for example a hinge with latching tabs, which secures the section which can be folded against unfolding inadvertently when in the folded-up state. It is also advantageous to provide the flat lamp with a depression, in which the section which can be folded can engage. This therefore prevents the flat lamp from sliding inadvertently within the frame when in the folded-up state.

In order to provide further support for the flat lamp, and to make it robust, it may be advantageous to additionally provide the folding frame with a rear wall adjacent to the rear face of the flat lamp, particularly in the case of very large-area and relatively thin flat lamps, in which the risk of breakage is, of course, particularly high, because of their filigree exterior. In this case, the rear wall can be inserted into the frame, or can be integrated with it to form an integral unit. In order to save weight, it is always preferable to provide the rear wall with cutouts, without this seriously adversely affecting the robustness. In some circumstances, it may also be sufficient for the rear wall to be in the form of a supporting cross.

The folding frame according to the invention thus links the advantage of mechanical simplicity and a small number of individual parts required with mechanical protection of the flat lamp, and its simple installation and replacement. Furthermore, electrical protection is provided by compliance with the required air gaps and creepage distances, for example for lights complying with the UL 1598 and EN 60598-1 Standards. The folding frame is therefore preferably composed of a material which is largely resistant to aging and ultraviolet, gases out as little as possible, has an electrical dielectric strength of, as far as possible, several kilovolts, in particular more than 5 kV, and is resistant to temperatures up to about 130° C. In particular, the following multicomponent plastics have been found to be suitable:

polyethylene (PE)/polypropylene (PP),
polymethyl methacrylate (PMM)/polystyrene (PS),
cellulose acetate (CA)/acrylonitrile butadiene styrene copolymer (ABS) and
polycarbonate (PC)/ABS.

### BRIEF DESCRIPTION OF THE DRAWINGS

The invention will be explained in more detail in the following text with reference to one exemplary embodiment. In the figures:

FIG. 1 shows a plan view of one exemplary embodiment of the lighting system according to the invention,

FIG. 2a shows a sectional illustration through the lighting system from FIG. 1, with the frame unfolded, and

FIG. 2a shows a sectional illustration through the lighting system from FIG. 1, with the frame folded up.

### PREFERRED EMBODIMENT OF THE INVENTION

Identical or functionally identical elements are provided with the same reference symbols in the figures.

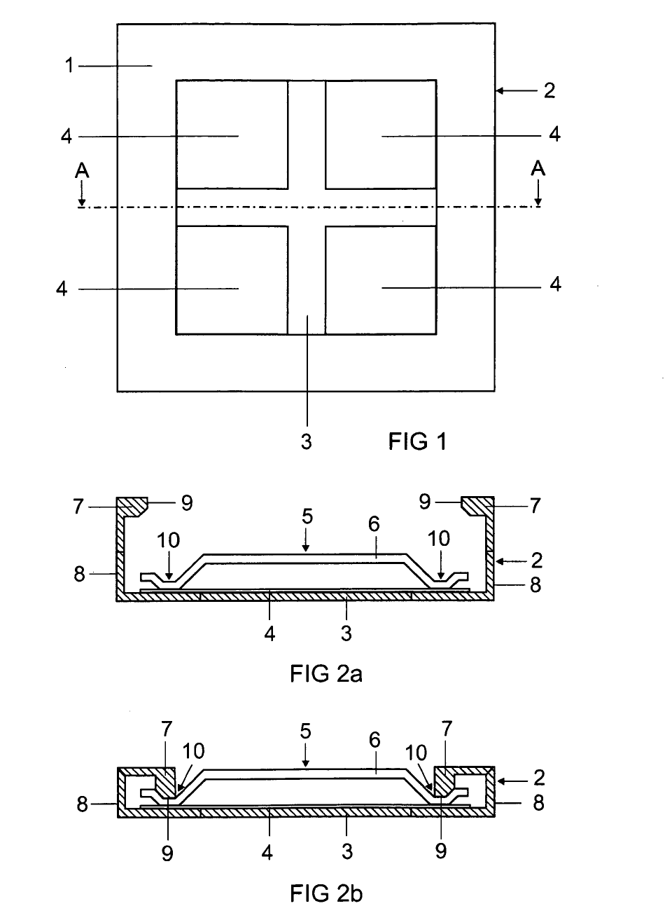

FIG. 1 shows, schematically, one exemplary embodiment of the lighting system according to the invention in the form of a plan view from underneath, that is to say of the side opposite the preferred light emission direction. This shows the circumferential lower face 1 of a folding frame 2 composed of PE/PP, a supporting cross 3 inserted in the lower face 1, as well as the baseplate 4 of a flat lamp, which can be seen through the four cutouts between the lower face 1 of the folding frame 2 and the arms of the supporting cross 3. The supporting cross 3 is used to support the flat lamp, whose baseplate 4 rests on the supporting cross 3. In principle, a baseplate drawn into the frame 2 may be used for support, as well. The supporting cross 3, however, carries out the same purpose, but advantageously with less weight than a solid baseplate.

The following text makes reference to FIGS. 2a and 2b, which each show a sectional illustration through the lighting system along the line AA, to be precise in the unfolded and folded-up state, respectively. In the unfolded state, the flat lamp 5—in this case, for the sake of simplicity, symbolized only by the already mentioned baseplate 4 and a front panel 6 which is connected to it to form a flat vessel, that is to say without electrodes and other details that are of no further interest here—can be inserted into the folding frame 2 without any problems. For this purpose, the folding frame 2 has a section 7 which can be folded and is connected by means of a conventional folding hinge (not illustrated in any more detail here) to the narrow face 8 of the folding frame 2. The narrow face 8 together with the lower face 1 in turn once again forms a unit with a right-angled profile. After insertion of the flat lamp 5, the section 7 which can be folded is folded up, and the flat lamp 5 is fixed in the folding frame 2. For this purpose, the section 7 which can be folded is shaped in the folded-up state, its free edge 9 engages in a circumferential groove 10 which is formed in the front panel 6 of the flat lamp 5. This secures the flat lamp 5 against sliding within the folding frame 2. In consequence, the entire lighting system can be stored, for example, in a light or a backlight unit, without the flat lamp 5 being able to inadvertently change its position. Furthermore, the flat lamp 5 is largely protected against the risk of breakage by the folding frame 2 and, in particular, the edges of the flat lamp 5 are protected against jolts. However, it is not just the installation of the flat lamp 5 in the folding frame 2 that is very simple, as already described. The flat lamp 5 can also be replaced very easily later, if required or in the event of a malfunction. For this purpose, the section 7 of the folding frame 2 which can be folded just has to be opened, and the flat lamp 5 replaced by another. Only the electrical connections of the power supply, which are preferably designed such that they can be plugged onto the flat lamp, also have to be considered.

1. A lighting system having
a flat lamp (5) which has a front face, which is intended for light emission, and a rear face opposite the front face,
a frame (2) which surrounds the edge of the flat lamp (2),
characterized in that
the frame (2) has a section (7) which can be folded and, when in the unfolded state, is suitable to allow the insertion of the flat lamp (5) and, in the folded-up state, fixes the frame (2) around the flat lamp (5).

2. The lighting system as claimed in claim 1, with the section (7) of the frame (2) which can be folded framing the front face of the flat lamp (5) when in the folded-up state.

3. The lighting system as claimed in claim 1, having a latching means which secures the section which can be folded against being unfolded inadvertently, when in the folded-up state.

4. The lighting system as claimed in claim 1, with the flat lamp (5) having a depression (10) in which the section (7) which can be folded engages and therefore prevents the flat lamp (5) from sliding inadvertently within the frame (2).

5. The lighting system as claimed in claim 1, with the section (7) of the frame (2) which can be folded comprising four segments which can be folded independently, and with each segment being associated with in each case one edge of the flat lamp (5).

6. The lighting system as claimed in claim 1, with the frame additionally having a rear wall which is adjacent to the rear face of the flat lamp.

7. The lighting system as claimed in claim 5, with the rear wall being provided with cutouts.

8. The lighting system as claimed in claim 5, with the rear wall being in the form of a supporting cross (3).

9. The lighting system as claimed in claim 1, with the frame (2) being composed of plastic.

10. The lighting system as claimed in claim 1, with the flat lamp being designed for operation by means of a dielectric barrier discharge.

11. The lighting system as claimed in claim 2, having a latching means which secures the section which can be folded against being unfolded inadvertently, when in the folded-up state.

12. The lighting system as claimed in claim 2, with the flat lamp (5) having a depression (10) in which the section (7) which can be folded engages and therefore prevents the flat lamp (5) from sliding inadvertently within the frame (2).

13. The lighting system as claimed in claim 2, with the section (7) of the frame (2) which can be folded comprising four segments which can be folded independently, and with each segment being associated with in each case one edge of the flat lamp (5).

14. The lighting system as claimed in claim 2, with the frame additionally having a rear wall which is adjacent to the rear face of the flat lamp.

15. The lighting system as claimed in claim 2, with the frame (2) being composed of plastic.

16. The lighting system as claimed in claim 2, with the flat lamp being designed for operation by means of a dielectric barrier discharge.
